(19) United States
(12) Patent Application Publication
(10) Pub. No.: US 2005/0185400 A1
(43) Pub. Date: Aug. 25, 2005

(54) Beaded decorative light string

(76) Inventor: Fu-Hsien Hsu, Taipei (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/784,246

(22) Filed: Feb. 24, 2004

(51) Int. Cl. F21V 1/00

(52) U.S. Cl. 362/238; 362/234; 362/249; 362/806; 362/807; 362/808

(57) ABSTRACT

A decorative light string includes electrical wires having first and second sections alternating each other, a lamp electrically and mechanically coupled each second section of the wires, a first decoration spherical bead mounted to each first section of the wires with at least a portion of the first section of the wires extending therethrough and a second decoration spherical bead mounted to each second section of the wires and forming an interior space for accommodating the lamp. The number of the first decoration beads mounted to each first section of the wires between adjacent second decoration beads can be set so that the first section of the wires is substantially covered by the first decoration beads between the adjacent second decoration beads.

### BACKGROUND OF THE INVENTION

1. Field of the Invention

The present invention relates generally to a decorative light string that is commonly used in celebrations and festivals, and in particular to a beaded decorative light string comprised of a plurality of hollow beads attached to wiring of the decorative light string for aesthetic purposes.

2. Description of the Prior Art

Light strings are widely used in celebrations and festivals for decoration purposes. Most of the light strings comprise a number of lamps mechanically and electrically connected together in a line by electrical wires. The wires are connected to a plug that is plugged to for example a wall outlet to power the lamps. A variety of designs are available in the market for the lamps. However, only very little effort has been devoted to the improvement for aesthetic purposes of the wiring of the light strings. In other words, conventionally, the wiring of the light string is for the purposes of connection between lamps only and no decoration has been done on the wiring.

Thus, the present invention is aimed to provide a light string of which the wiring is provided with decoration.

### SUMMARY OF THE INVENTION

An object of the present invention is to provide a decorative light string comprising decorated wiring connecting lamps.

Another object of the present invention is to provide a decorative light string comprising wiring connecting lamps and decorative beads attached to the wiring for decoration.

A further object of the present invention is to provide a light string having enhanced decoration on both wiring and lamps.

To achieve the above objects, in accordance with the present invention, there is provided a decorative light string comprising electrical wires having first and second sections alternating each other, a lamp electrically and mechanically coupled each second section of the wires, a first decoration spherical bead mounted to each first section of the wires with at least a portion of the first section of the wires extending therethrough and a second decoration spherical bead mounted to each second section of the wires and forming an interior space for accommodating the lamp. The number of the first decoration beads mounted to each first section of the wires between adjacent second decoration beads can be set so that the first section of the wires is substantially covered by the first decoration beads between the adjacent second decoration beads.

### BRIEF DESCRIPTION OF THE DRAWINGS

The present invention will be apparent to those skilled in the art by reading the following description of preferred embodiments thereof, with reference to the attached drawings, in which:

FIG. 1 is a perspective view of a beaded decorative light string constructed in accordance with a preferred embodiment of the present invention with some beads opened to show inside details;

FIG. 2 is a cross-sectional view of the beaded decorative light string in accordance with the present invention;

FIG. 3 is a perspective view of a portion of a beaded decorative light string constructed in accordance with another embodiment of the present invention, with a bead opened to show inside details;

FIG. 4 is similar to FIG. 3 but showing a beaded decorative light string constructed in accordance with a further embodiment of the present invention, which is a modification of the embodiment illustrated in FIG. 3;

FIG. 5 is a schematic view showing an application of the beaded decorative light string of the present invention; and

FIGS. 6 and 7 are perspective views of beaded decorative light strings constructed in accordance with further embodiments of the present invention wherein some beads are replaced by figures of other shapes.

### DETAILED DESCRIPTION OF PREFERRED EMBODIMENTS

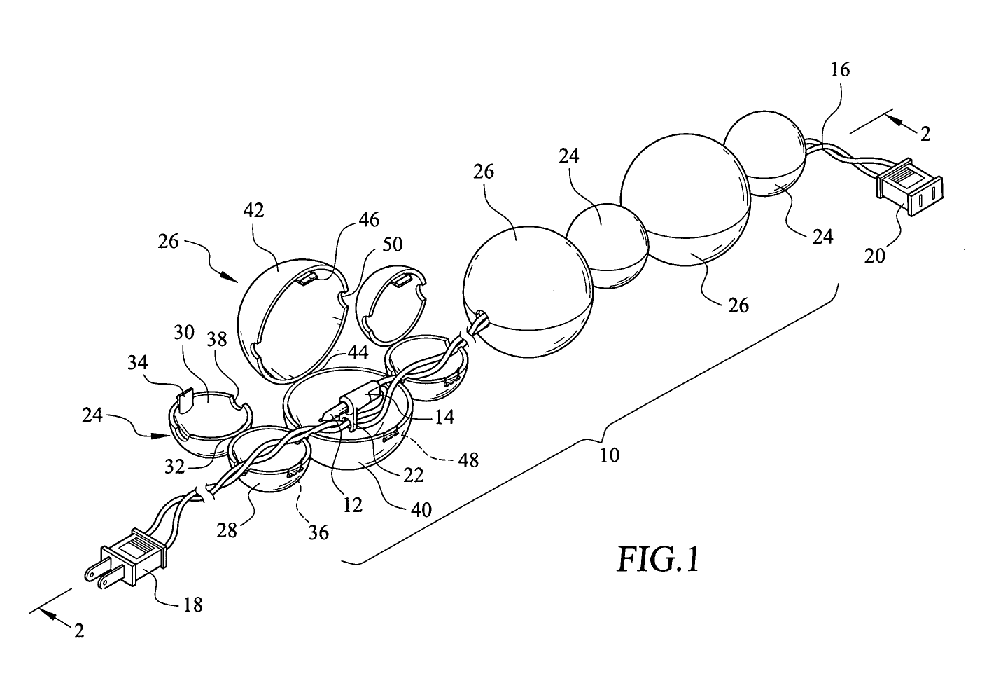

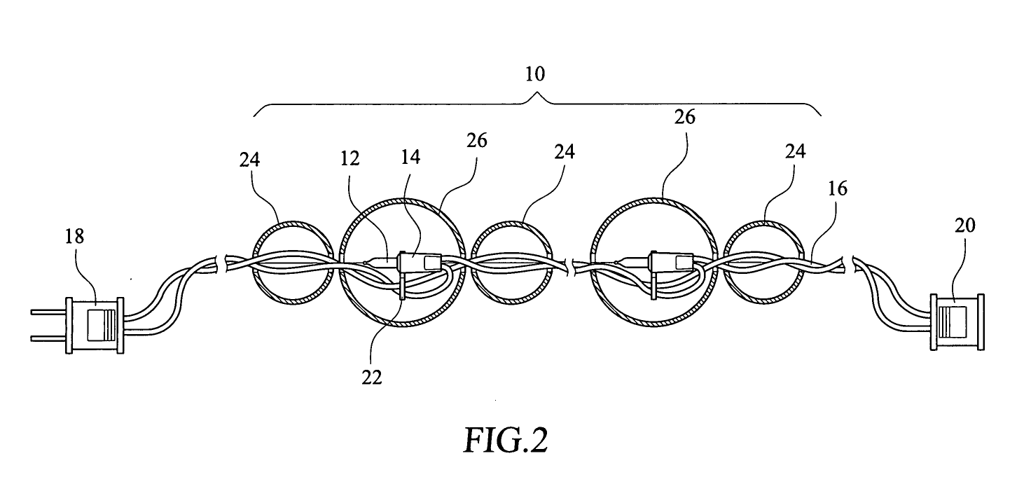

With reference to the drawings and in particular to FIGS. 1 and 2, a beaded decorative light string constructed in accordance with the present invention, generally designated with reference numeral 10, comprises a length of electrical wires 16 comprised of first and second sections (not labeled) alternating each other and a number of lamps 12 retained by lamp sockets 14 that are mechanically and electrically connected to the second sections of the electrical wires 16. A plug 18 is connected to the wires 16 for selectively plugging into for example a wall outlet (not shown) to supply electricity to the lamps 12. Optionally, a socket 20 is mounted to the wires 16 for selective connection with a plug of an electrical device (not shown), such as another light string.

The lamp socket 14 is preferably plastic molded and is provided with a clip 22 that engages the wires 16 for further fixing the lamp 12 to the second section of the wires 16 in a substantially parallel manner. This makes the lamps 12 more securely attached to the wires 16 and makes the assembly of the lamps 12 and the wires 16 more compact.

Decoration members 24, 26 are respectively mounted to the first and second sections of the wires 16 whereby the decoration member 24, 26 covers or surrounds at least a portion of the first or second section of the wires 16. The number of the first decoration members 24 mounted to first section of the wires 16 between adjacent second decoration members 26 can be changed arbitrarily whereby at least a portion of the first section of the wires 16 is surrounded by the first decoration members 24, while the second section of the wires 16 is covered by the second decoration member 26. In the embodiment illustrated, the decoration members 24 are made in the form of hollow sphere or bead and this is the same to the decoration members 26. However, the second bead 26 has a diameter larger than that of the first bead 24. The difference in size between the first and second beads 24, 26 is for accommodation of the lamp 12 in the second bead 26 and also for variation of the overall outer appearance of the light string 10. However, it is apparent that both the first and second beads 24, 26 can be made the same size and shape.

The first bead 24 that is spherical comprises two hemi-spherical halves 28, 30 connected in a hinging manner at a position 32 along an opening edge thereof. A coupling device is also provide between the first and second halves 28, 30, comprising a pawl 34, preferably resilient, formed on the second half 30, preferably at a position substantially opposite to the hinge 32, and, corresponding to the pawl 34, a slot or recess 36 defined in the first half 28 for resiliently engaging the pawl 34 for example in a snap-on manner to fix the first and second halves 28, 30 together. It is apparent that the hinge 32 can be replaced by another coupling means, such as that of the pawl-recess pair. It is also apparent that the coupling device can be replaced by any known coupling means, of which examples include ultra-sonic welding and adhesives.

Notches 38 are defined in the opening edges of both the first and second halves 28, 30 and corresponding in position to each other. When the first and second halves 28, 30 are fixed to each other, the notches 38 form openings through which the first section of the wires 16 extends. The openings are of such a size that forms a tight engagement with the wires 16 by slight deformation of at least one of the halves 28, 30 and the wires 16. Thus, the first bead 24 is securely attached to the wires 16 substantially with no relative movement with respect to the wires 16.

The second bead 26 in the embodiment illustrated has substantially identical structure. In other words, the second bead 26 comprises first and second halves 40, 42 hinged together at 44 and coupled to each other by a coupling device comprised of a resilient pawl 46 and a recess 48. Notches 50 are defined in opening edges of the halves 40, 42, which when the halves 40, 42 are fixed together, form openings for the extension of the second section of the wires 16.

It is noted that the lamps 12 are accommodated in the second beads 26 in a floating manner in the embodiment illustrated in FIGS. 1 and 2. In other words, the lamp 12 or the lamp socket 14 is not directly fixed to either one of the halves 40, 42 of the second bead 26.

It is noted that the first and second beads 24, 26 can be made of any suitable materials, such as plastics, metals, paper materials, glass, and wood, and can be formed with any desired patterns. However, it is apparent that the second beads 26 that accommodate the lamps 12 must be transparent or translucent to allow radiation of the light emitted from the lamps 12 therethrough.

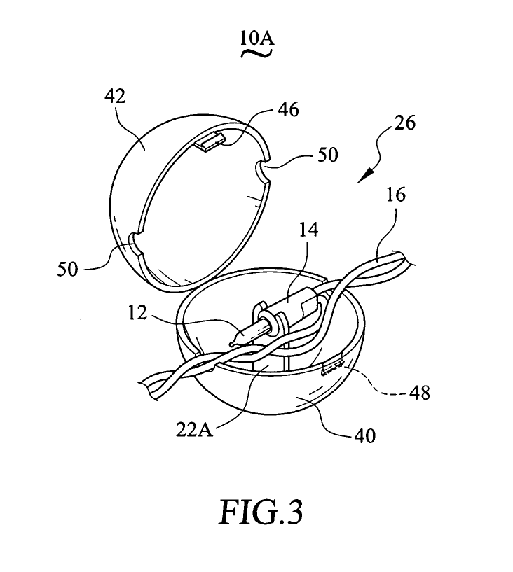

Also referring to FIG. 3, which shows another embodiment of the beaded decorative light string in accordance with the present invention, generally designated with reference numeral 10A, the beaded decorative light string 10A is substantially similar to the beaded decorative light string 10 with reference to FIGS. 1 and 2 whereby identical parts are designated with the same reference numerals and are not described in details for simplifying the description. The beaded decorative light string 10A comprises wires 16 to which a lamp socket 14 retaining a lamp 12 is connected, and first and second beads (only second bead 26 being visible in FIG. 3) attached to the first and second sections of the wires 16, respectively, for decoration purposes.

In the beaded decorative light string 10A, the lamp socket 14 is not provided with a wire clip and instead, a mount 22A is formed in the second half 40 to receive and retain the lamp socket 14 so as to fix the lamp 12, as well as the second section of the wires 16, if desired, inside the second bead 26. It is thus noted that in the beaded decorative light string 10A, the lamp 12 is fixed to the second bead 26, rather than floating inside the bead 26 as illustrated in FIGS. 1 and 2.

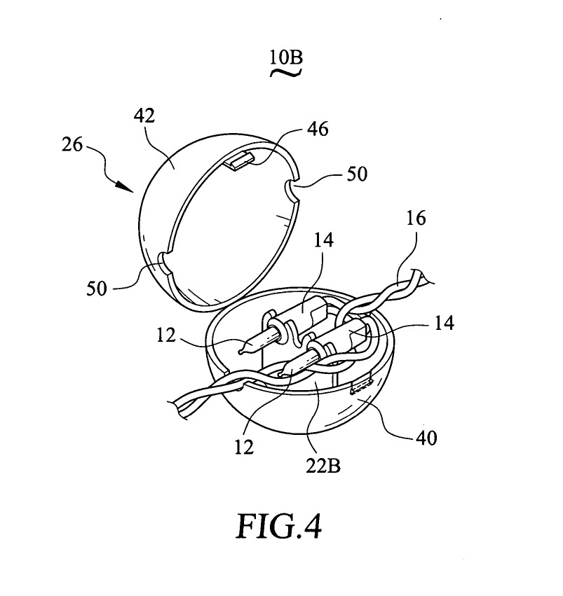

Referring to FIG. 4, which shows a further embodiment of the beaded decorative light string in accordance with the present invention, generally designated with reference numeral 10B, the beaded decorative light string 10B is a modification of the beaded decorative light string 10A with reference to FIG. 3 whereby identical parts are designated with the same reference numerals and are not described in details for simplifying the description. The beaded decorative light string 10B comprises wires 16 to which lamp sockets 14 is connected, and first and second beads (only second bead 26 being visible in FIG. 4) attached to first and second sections of the wires 16, respectively, for decoration purposes.

In the beaded decorative light string 10B, two lamp sockets 14 are accommodated and fixed in the second bead 26 by a mount 22B formed in the second half 40 to receive the lamp sockets 14 so as to fix the lamps 12 inside the second bead 26. It is noted that if desired, the number of the lamps 12 accommodated inside each second bead 26 can be increased and is only subject to the constraints imposed by the physical size of the second bead 26.

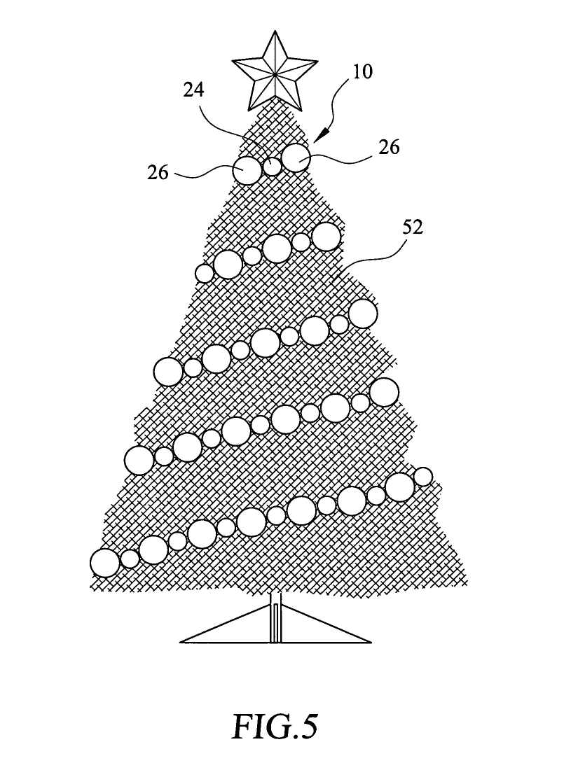

FIG. 5 shows an application of the light string 10 (or 10A, 10B) of the present invention, wherein the light string 10 (10A, 10B) is wound around a Christmas tree 52 for illuminative decoration purposes. It is certainly apparent that the light string 10, 10A, 10B of the present invention can be used in the same way as any conventional light strings for decoration and thus no detail is needed herein.

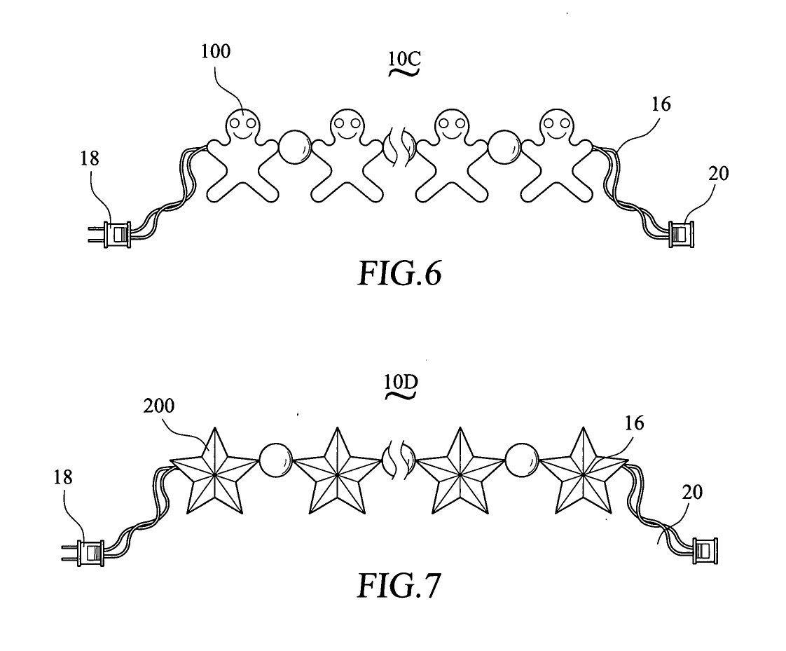

Although in the above discussion, the decoration members 24, 26 are made spherical, in the form of “beads”, it is apparent to those having ordinary skills to shape the decoration members in different forms, such as a contour of a doll, designated with reference numeral 100 in FIG. 6, and a star 200 in FIG. 7. In the embodiments illustrated in FIGS. 6 and 7, only some of the beads are replaced by the doll figures 100 or stars 200 whereby the doll figures 100 (or the stars 200) are alternating with the beads. The lamps of the light strings 10C of FIG. 6 (or light string 10D of FIG. 7) that are attached to wires 16 can be accommodated in each or some of the doll figures 100 (or each or some of the stars 200). Alternatively, the lamps can be accommodated in the beads or a combination of the beads and the doll figures (or the stars). This provides a great variation of the overall configuration of the light string in accordance with the present invention.

Although the present invention has been described with reference to the preferred embodiments thereof, it is apparent to those skilled in the art that a variety of modifications and changes may be made without departing from the scope of the present invention which is intended to be defined by the appended claims.

1. A decorative light string comprising:
electrical wires having at least a first section and a second section;
at least one lamp electrically and mechanically coupled the second section of the wires; and
a first decoration member attached to each first section of the wires with the first section of the wires extending through the first decoration member whereby the first section of the wires is housed in the first decoration member.

2. The decorative light string as claimed in claim 1, wherein the first decoration member comprises a first sphere defining openings through which the first section of the wires extends.

3. The decorative light string as claimed in claim 2, wherein the first sphere comprises first and second portions attached to each other.

4. The decorative light string as claimed in claim 3, wherein the first sphere is hollow and comprises first and second hemi-spherical members having opening edges attached to each other, notches being defined in the opening edges and forming the openings when the first and second hemi-spherical members are attached to each other.

5. The decorative light string as claimed in claim 3, wherein the first and second portions are hinged to each other at a first position and releasably coupled to each other at a second position substantially opposite to each other.

6. The decorative light string as claimed in claim 5, wherein the coupling between the first and second portions comprises a resilient pawl engageable with a recess, both being formed in the first and second portions respectively.

7. The decorative light string as claimed in claim 1 further comprising a second, hollow decoration member accommodating the lamp therein and surrounding the second section of the wires.

8. The decorative light string as claimed in claim 7, wherein the second hollow decoration member a second sphere defining openings through which the second section of the wires extends whereby the second section of the wires is housed in the second decoration member.

9. The decorative light string as claimed in claim 2, wherein the second sphere comprises first and second portions attached to each other.

10. The decorative light string as claimed in claim 9, wherein the second sphere comprises first and second hemi-spherical members having opening edges attached to each other, notches being defined in the opening edges and forming the openings when the first and second hemi-spherical members are attached to each other.

11. The decorative light string as claimed in claim 9, wherein the first and second portions of the second sphere are hinged to each other at a first position and releasably coupled to each other at a second position substantially opposite to each other.

12. The decorative light string as claimed in claim 11, wherein the coupling between the first and second portions of the second sphere comprises a resilient pawl engageable with a recess, both being formed in the first and second portions of the second sphere respectively.

13. The decorative light string as claimed in claim 7 comprising two lamps accommodated in the second decoration member.

14. The decorative light string as claimed in claim 7, wherein the lamp comprises a clip engaging the first section of the wires.

15. The decorative light string as claimed in claim 7, wherein the second sphere forms a mount that receives and retains the lamp inside the second sphere.

16. The decorative light string as claimed in claim 13, wherein the second sphere forms a mount that receives and retains the lamps inside the second sphere.

17. The decorative light string as claimed in claim 1, wherein the first decoration member has a configuration of a doll figure.

18. The decorative light string as claimed in claim 1, wherein the first decoration has a star shape.

19. The decorative light string as claimed in claim 7, wherein the second decoration member has a configuration of a doll figure.

20. The decorative light string as claimed in claim 7, wherein the second decoration has a star shape.
